(19) United States
(12) Patent Application Publication
(10) Pub. No.: US 2019/0333440 A1
(43) Pub. Date: Oct. 31, 2019

(54) Driving device for display panel and display device

(71) Applicant: Xianyang Caihong Optoelectronics Technology Co.,Ltd, XIANYANG (CN)

(72) Inventors: PENGGANG CHANG, XIANYANG (CN); YUYEH CHEN, XIANYANG (CN); KUN WANG, XIANYANG (CN); YUAN-LIANG WU, XIANYANG (CN)

(21) Appl. No.: 16/391,585

(22) Filed: Apr. 23, 2019

(30) Foreign Application Priority Data
Apr. 28, 2018 (CN) 2018206307341

(51) Int. Cl. G09G 3/20; G09G 3/36

(52) U.S. Cl. CPC G09G 3/2096; G09G 3/3674; G09G 2310/0289; G09G 3/3696; G09G 2310/08; G09G 3/3685

(57) ABSTRACT

The application relates to a driving device for a display panel, including: a system-on-chip, a first transmission circuit board, a second transmission circuit board, a source driver and a gate driver. The first transmission circuit board and the second transmission circuit board are juxtaposed on the source side of the display panel and connected by a connector, the source driver includes a plurality of source chip on films on the source side and connected to the display panel, the first transmission circuit board and the second transmission circuit board are respectively connected to corresponding ones of the plurality of source chip on films. The signal transmission distances of the data output end of the system-on-chip to the source COFs respectively connected to symmetrical positions of the display panel are equal, ensuring the symmetry and stability of the transmitted signal.

### FIELD OF THE DISCLOSURE

The present application relates to the field of display technologies, and in particular to a driving device for a display panel and a display device.

### BACKGROUND OF THE DISCLOSURE

With the accelerated development of thin film transistor liquid crystal displays (TFT-LCDs), 4K HD and above have become the mainstream of the industry display. The existing TFT-LCD display mainly includes a system-on-chip (SoC), a timing control board, a gate driver, a transmission circuit board, and a source driver. A system-on-chip receives an image data signal to be transmitted, and outputs the image data signal to be transmitted, and then processes the input signal through a row expansion module and a column expansion module. The processed data is provided to a timing control (T-CON) board, and the T-CON board transmits the received data to the gate driver and the source driver through the transmission circuit board. Moreover, two spaced flexible flat cable (FFC) connections are required between the T-CON board and the transmission board.

As the market competition becomes more and more fierce, how to reduce the display area of the liquid crystal panel without affecting the display effect of the liquid crystal panel becomes a technical problem to be solved.

### SUMMARY OF THE DISCLOSURE

In order to solve the above problems in the prior art, the present application provides a driving device for a display panel and a display device. The technical problem to be solved by the present application is achieved by the following technical solutions.

The present application provides a driving device for a display panel, including a system-on-chip, a first transmission circuit board, a second transmission circuit board, a source driver and a gate driver. Wherein the first transmission circuit board and the second transmission circuit board are juxtaposed on a source side of the display panel and connected by a connector, the source driver includes a plurality of source chip on films (COFs) on the source side and connected to the display panel, the first transmission circuit board and the second transmission circuit board are respectively connected to corresponding ones of the plurality of source COFs. An output signal of the system-on-chip in operation is transmitted to the corresponding source COF via the first transmission circuit board, or transmitted to the corresponding source COF via a transmission path formed sequentially by the first transmission circuit board, the connector, and the second transmission circuit board, such that the signal transmission distances from the data output end of the system-on-chip to the source COF respectively connected to the symmetrical positions of the display panel are equal.

In one embodiment of the present application, the length of the first transmission circuit board is greater than the length of the second transmission circuit board, and the number of the source COFs connected to the first transmission circuit board is greater than the number of the source COFs connected to the second transmission circuit board.

In one embodiment of the present application, the driving device further includes a second connector, the data output end of the system-on-chip being connected to the first transmission circuit board through the second connector.

In one embodiment of the present application, the second connector is one flexible flat cable (FFC), so that the circuit board where the system-on-chip is located and the first transmission circuit board are electrically connected only through the single flexible flat cable.

In one embodiment of the present application, a power circuit chip is disposed on the first transmission circuit board, and the power circuit chip is connected to the system-on-chip, the source driver, the gate driver, and the common electrode of the display panel; the power circuit chip is configured to generate a plurality of power supply voltages to the source driver and the gate driver, generate gamma voltage signals to the source driver, generate a common electrode voltage signal to the common electrode, and generate timing control voltage signals to the gate driver.

In one embodiment of the present application, the first transmission circuit board is provided with a power management chip and a voltage management chip; the power management chip is connected to the source driver, the gate driver, and the voltage management chip, and is configured to generate a plurality of power supply voltages to the source driver, the gate driver, and the voltage management chip; the voltage management chip is connected to the system-on-chip, the source driver, the common electrode of the display panel, and the gate driver, and is configured to generate gamma voltage signals to the source driver, generate a common electrode voltage signal to the common electrode, and generate timing control voltage signals to the gate driver.

In one embodiment of the present application, the first transmission circuit board is provided with a voltage management chip and a level shifting chip; the voltage management chip is connected to the source driver, the gate driver, the common electrode of the display panel, and the level shifting chip, and is configured to generate a plurality of power supply voltages to the source driver, the gate driver, and the level shifting chip, generate gamma voltage signals to the source driver and generate a common electrode voltage signal to the common electrode; the level shifting chip is coupled to the system-on-chip and the gate driver for generating timing control voltage signals to the gate driver.

In one embodiment of the present application, the first transmission circuit board is provided with a voltage management chip and a gamma and common voltage generating chip; the voltage management chip is connected to the system-on-chip, the source driver, the gate driver, and the gamma and common voltage generating chip, and is configured to generate a plurality of power supply voltages to the source driver, the gate driver and the gamma and common voltage generating chip, and generate timing control voltage signals to the gate driver; the gamma and common voltage generating chip connects the source driver and the common electrode of the display panel, and is configured to generate gamma voltage signals to the source driver and generate a common electrode voltage signal to the common electrode.

In one embodiment of the present application, the first transmission circuit board is provided with a power management chip, a gamma and common voltage generating chip and a level shifting chip; the power management chip is connected to the source driver, the gate driver, the gamma and common voltage generating chip, and the level shifting chip, and is configured to generate a plurality of power supply voltages to the source driver, the gate driver, the gamma and common voltage generating chip, and the level shifting chip; the gamma and common voltage generating chip connects the source driver and the common electrode of the display panel, and is configured to generate gamma voltage signals to the source driver and generate a common electrode voltage signal to the common electrode; the level shifting chip is connected to the system-on-chip and the gate driver, and is configured to generate timing control voltage signals to the gate driver.

Another aspect of the present application provides a display device including a display panel, and a driving device for the display panel. Wherein the driving device includes: a system-on-chip, a first transmission circuit board, a second transmission circuit board, a source driver and a gate driver. Wherein the first transmission circuit board and the second transmission circuit board are juxtaposed on a source side of the display panel and connected by a connector, the source driver includes a plurality of source chip on films (COFs) on the source side and connected to the display panel, the first transmission circuit board and the second transmission circuit board are respectively connected to corresponding ones of the plurality of source COFs. An output signal of the system-on-chip in operation is transmitted to the corresponding source COF via the first transmission circuit board, or transmitted to the corresponding source COF via a transmission path formed sequentially by the first transmission circuit board, the connector, and the second transmission circuit board, such that the signal transmission distances from the data output end of the system-on-chip to the source COF respectively connected to the symmetrical positions of the display panel are equal.

In one embodiment of the present application, the length of the first transmission circuit board is greater than the length of the second transmission circuit board, and the number of the source COFs connected to the first transmission circuit board is greater than the number of the source COFs connected to the second transmission circuit board.

In one embodiment of the present application, the driving device further includes a second connector, the data output end of the system-on-chip being connected to the first transmission circuit board through the second connector.

In one embodiment of the present application, the second connector is one flexible flat cable (FFC), so that the circuit board where the system-on-chip is located and the first transmission circuit board are electrically connected only through the single flexible flat cable.

In one embodiment of the present application, a power circuit chip is disposed on the first transmission circuit board, and the power circuit chip is connected to the system-on-chip, the source driver, the gate driver, and the common electrode of the display panel; the power circuit chip is configured to generate a plurality of power supply voltages to the source driver and the gate driver, generate gamma voltage signals to the source driver, generate a common electrode voltage signal to the common electrode, and generate timing control voltage signals to the gate driver.

In one embodiment of the present application, the first transmission circuit board is provided with a power management chip and a voltage management chip; the power management chip is connected to the source driver, the gate driver, and the voltage management chip, and is configured to generate a plurality of power supply voltages to the source driver, the gate driver, and the voltage management chip; the voltage management chip is connected to the system-on-chip, the source driver, the common electrode of the display panel, and the gate driver, and is configured to generate gamma voltage signals to the source driver, generate a common electrode voltage signal to the common electrode, and generate timing control voltage signals to the gate driver.

In one embodiment of the present application, the first transmission circuit board is provided with a voltage management chip and a level shifting chip; the voltage management chip is connected to the source driver, the gate driver, the common electrode of the display panel, and the level shifting chip, and is configured to generate a plurality of power supply voltages to the source driver, the gate driver, and the level shifting chip, generate gamma voltage signals to the source driver and generate a common electrode voltage signal to the common electrode; the level shifting chip is coupled to the system-on-chip and the gate driver for generating timing control voltage signals to the gate driver.

In one embodiment of the present application, the first transmission circuit board is provided with a voltage management chip and a gamma and common voltage generating chip; the voltage management chip is connected to the system-on-chip, the source driver, the gate driver, and the gamma and common voltage generating chip, and is configured to generate a plurality of power supply voltages to the source driver, the gate driver and the gamma and common voltage generating chip, and generate timing control voltage signals to the gate driver; the gamma and common voltage generating chip connects the source driver and the common electrode of the display panel, and is configured to generate gamma voltage signals to the source driver and generate a common electrode voltage signal to the common electrode.

In one embodiment of the present application, the first transmission circuit board is provided with a power management chip, a gamma and common voltage generating chip and a level shifting chip; the power management chip is connected to the source driver, the gate driver, the gamma and common voltage generating chip, and the level shifting chip, and is configured to generate a plurality of power supply voltages to the source driver, the gate driver, the gamma and common voltage generating chip, and the level shifting chip; the gamma and common voltage generating chip connects the source driver and the common electrode of the display panel, and is configured to generate gamma voltage signals to the source driver and generate a common electrode voltage signal to the common electrode; the level shifting chip is connected to the system-on-chip and the gate driver, and is configured to generate timing control voltage signals to the gate driver.

Compared with the prior art, the beneficial effects of the embodiments of the present application are as follows:

(1) The driving device of the display panel of the embodiment of the present application omits the timing control board in the prior art symmetric display panel driving device and connects the system-on-chip to the first transmission circuit board, thereby reducing the area of the driving device and reducing the cost.

(2) The driving device of the embodiment of the present application adopts an asymmetric design of the first transmission circuit board and the second transmission circuit board, that is, the lengths of the first transmission circuit board and the second transmission circuit board are different. Therefore, it is ensured that the signal transmission distances from the source COF respectively connected to the output of the system-on-chip on the first transmission circuit board to the symmetrical positions on the side of the display panel are equal, thereby ensuring the stability of the output signal from the system-on-chip.

(3) In the embodiment of the present application, a power supply circuit that generates a plurality of power supply voltages, gamma voltage signals, common electrode voltage signals, and timing control voltage signals is integrated on the first transmission circuit board in the form of a single chip or a multi-chip. The display device factory does not need to separately add the foregoing power circuit on the circuit board where the SoC is located when the circuit board design of the original system-on-chip (SoC) is selected to use the system-on-chip including the T-CON function. It reduces the design complexity and difficulty of the circuit where the system-on-chip is located, which is simple and quick.

(4) The embodiment of the present application integrates a power supply circuit that generates a plurality of power supply voltages, gamma voltage signals, common electrode voltage signals, and timing control voltage signals on the first transmission circuit board. Therefore, the circuit board on which the system-on-chip is located can be connected to the first transmission circuit board through one flexible flat cable, thereby saving one flexible flat cable compared with the prior art.

### BRIEF DESCRIPTION OF THE DRAWINGS

In order to more clearly illustrate the technical solutions of the embodiments of the present application, the drawings used in the description of the embodiments will be briefly described below. Obviously, the drawings in the following description are only some of the embodiments of the present application, and those skilled in the art can obtain other drawings according to the drawings without any creative work.

FIG. 1 is a schematic structural diagram of a display device including a display panel and a driving device according to an embodiment of the present application.

FIG. 2 is a schematic structural diagram of another display device including a display panel and a driving device thereof according to an embodiment of the present application.

FIG. 3 is a schematic structural diagram of still another display device including a display panel and a driving device thereof according to an embodiment of the present application.

FIG. 4 is a schematic diagram showing the connection relationship between the power circuit chip and the related components shown in FIG. 3.

FIG. 5 is a schematic structural diagram of still another display device including a display panel and a driving device thereof according to an embodiment of the present application.

FIG. 6A is a schematic diagram showing the connection relationship between a power management chip and a voltage management chip and related components in a specific embodiment of the display device shown in FIG. 5.

FIG. 6B is a schematic diagram showing the connection relationship between the level shifting chip and the voltage management chip and related components in the display device of FIG. 5 in another specific embodiment.

FIG. 6C is a schematic diagram showing the connection relationship between the gamma and common voltage generating chips and the voltage management chip and related components in the display device of FIG. 5 in still another embodiment.

FIG. 7 is a schematic structural diagram of still another display device including a display panel and a driving device thereof according to an embodiment of the present application.

FIG. 8 is a schematic diagram showing the connection relationship between the power management chip, the gamma and common voltage generating chips, and the level shifting chip and related components shown in FIG. 7.

### DETAILED DESCRIPTION OF PREFERRED EMBODIMENTS

The technical solutions in the embodiments of the present application are clearly and completely described in the following with reference to the drawings in the embodiments of the present application. It is obvious that the described embodiments are only a part of the embodiments of the present application, and not all of the embodiments. All other embodiments obtained by a person of ordinary skill in the art based on the embodiments of the present application without departing from the inventive scope are the scope of the present application.

### Embodiment 1

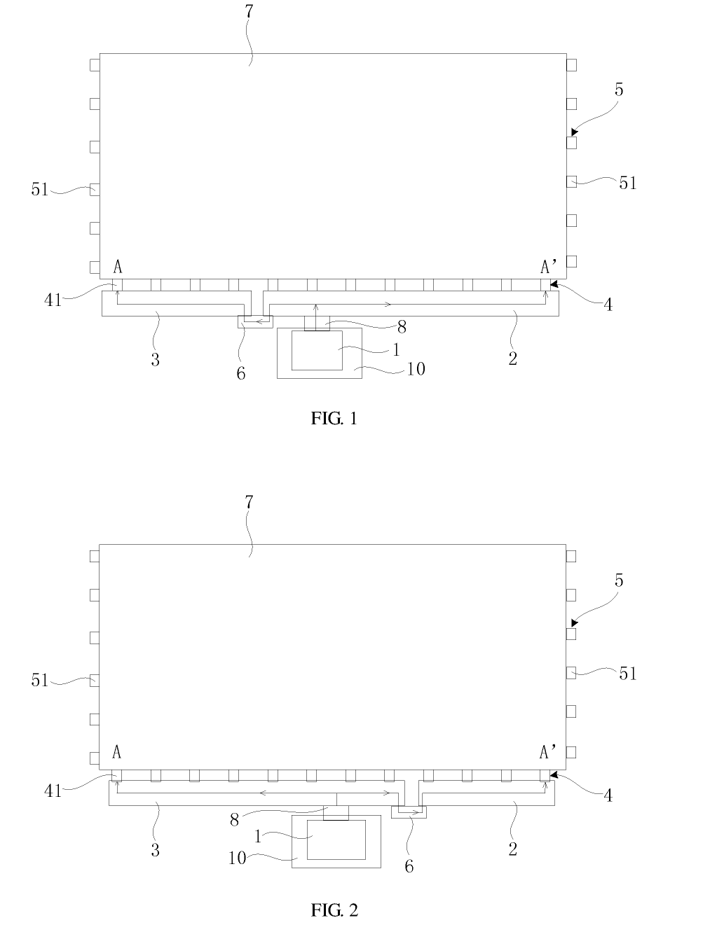

Please refer to FIG. 1. FIG. 1 is a schematic structural diagram of a display device including a display panel and a driving device thereof according to an embodiment of the present application. As shown in FIG. 1, the driving device of the display panel of the present embodiment includes a system-on-chip 1, a transmission circuit board 2, a transmission circuit board 3, a source driver 4, and a gate driver 5. The system-on-chip 1 is configured to receive an image data signal to be transmitted and output the image signal to be transmitted, which typically has a built-in timing control (T-CON) function. The transmission circuit board 2 and the transmission circuit board 3 are spaced apart from each other on the source side of the display panel 7 and are connected to each other by a detachable connector 6. The source driver 4 includes a plurality of source COFs (chip on films) 41 connected to the display panel 7, and the transfer circuit board 2 and the transfer circuit board 3 are respectively connected to the corresponding source COF 41.

As shown in FIG. 1, the transmission circuit board 2 is connected to a part of the source COF 41 of the plurality of source COFs 41, and the transmission circuit board 3 is connected to the remaining part of the plurality of source COFs 41. In the present embodiment, the output of the system-on-chip 1 is connected to the transmission circuit board 2 and is adjacent to the connector 6. And, as indicated by the arrows in FIG. 1, the image transmission signal outputted from the output terminal of the system-on-chip 1 can be transmitted to the corresponding source COF 41 of the source driver 4 through the transmission circuit board 2 (for example, the eight source COF 41 on the right side of the connector 6 in FIG. 1), or can be transmitted to the corresponding source COF 41 of the source driver 4 through a transmission path formed by the transmission circuit board 2, the connector 6 and the transmission circuit board 3 (for example, the four source COF 41 on the left side of the connector 6 in FIG. 1). It is worth mentioning here that, in the case of the twelve source COF 41 of FIG. 1, there are six pairs of symmetrical positions, and only a pair of symmetrical positions A, A′ are shown in FIG. 1 as a schematic illustration.

In the above embodiment, in the present embodiment, in order to ensure that the signal transmission distances from the output end of the system-on-chip 1 to the source COF 41 respectively connected to the symmetrical positions of the display panel 7 are equal (for example, two COF A and COF A′ at the symmetrical positions in FIG. 1 respectively), the length of the transmission circuit board 2 is larger than the length of the transmission circuit board 3, and the number of the source COF 41 connected to the transmission circuit board 2 is larger than the number of the source COF 41 connected to the transmission circuit board 3.

For example, in this embodiment, as shown in FIG. 1, there are twelve source-flip-coated films 41 uniformly distributed on the lower side of the display panel 7, and the length of the transmission circuit board 2 is about twice the length of the transmission circuit board 3. That is, the transmission circuit board 2 is connected to the eight source COF 41 on the right side, and the transmission circuit board 3 is connected to the four source COF 41 on the left side. At the same time, the output of the system-on-chip 1 is located below the position between the two adjacent source-transparent films in the middle of the figure. In this way, the signal transmission distances reaching the source COF 41 respectively connected to the symmetrical positions of the display panel 7 are equal according to the direction of the arrow. Of course, the number of the source COF 41 and the length of the transmission circuit board 2 and the transmission circuit board 3 can be flexibly set according to actual conditions. It suffices that the signal transmission distance from the output end of the system-on-chip 1 to the source COF 41 respectively connected to the symmetrical positions of the display panel 7 can be made equal.

Referring to FIG. 2, FIG. 2 is a schematic structural diagram of another display device including a display panel and a driving device thereof according to an embodiment of the present application. It is worth noting that in the specific embodiment shown in FIG. 2, the output of the system-on-chip 1 is connected to the transmission circuit board 3. At the same time, the length of the transmission circuit board 2 is smaller than the length of the transmission circuit board 3, and the number of the source COF 41 connected to the transmission circuit board 2 is smaller than the number of the source COF 41 connected to the transmission circuit board 3. At this time, the image transmission signal outputted from the output terminal of the system-on-chip 1 can be transmitted to the corresponding source COF 41 of the source driver 4 through the transmission circuit board 3, or be transmitted to the corresponding source COF 41 of the source driver 4 through a transmission path formed by the transmission circuit board 3, the connector 6 and the transmission circuit board 2. This also makes it possible to achieve equal signal transmission distances from the output end of the system-on-chip 1 to the source COF 41 at the symmetrical positions connected to the display panel 7.

Further, as shown in FIGS. 1 and 2, the driving device of the present embodiment further includes a connector 8, and the output end of the system-on-chip 1 is electrically connected to the transmission circuit board 2 or the transmission circuit board 3 through the detachable connector 8. Further, in a specific embodiment, the connector 8 is one flexible flat cable (FFC), so that the circuit board 10 on which the system-on-chip 1 is located and the transmission circuit board 2 or the transmission circuit board 3 are electrically connected only by one flexible flat cable.

In summary, the driving device of the display panel of the present embodiment adopts an asymmetric design of the transmission circuit board 2 and the transmission circuit board 3, that is, the lengths of the transmission circuit board 2 and the transmission circuit board 3 are different. Therefore, it is easy to ensure that the signal transmission distances from the output terminals of the system-on-chip 1 respectively connected to the transmission circuit board 2 or the transmission circuit board 3 to the source COF 41 respectively connected to the symmetrical positions of the display panel 7 are equal, thereby ensuring the stability of the output signal from the system-on-chip 1. Furthermore, the display panel of the present embodiment omits the timing control board in the prior art symmetric liquid crystal display panel driving device and connects the system-on-chip 1 to the transmission circuit board 2 (or 3), which reduces the area of the driving device and reduces the cost. Moreover, the use of one flexible flat cable between the circuit board 10 and the transmission circuit board 2 or the transmission circuit board 3 can save a soft cable line compared with the prior art. Thereby, the purpose of further reducing the size of the circuit board 10 can be achieved, and the product cost can be reduced.

### Embodiment 2

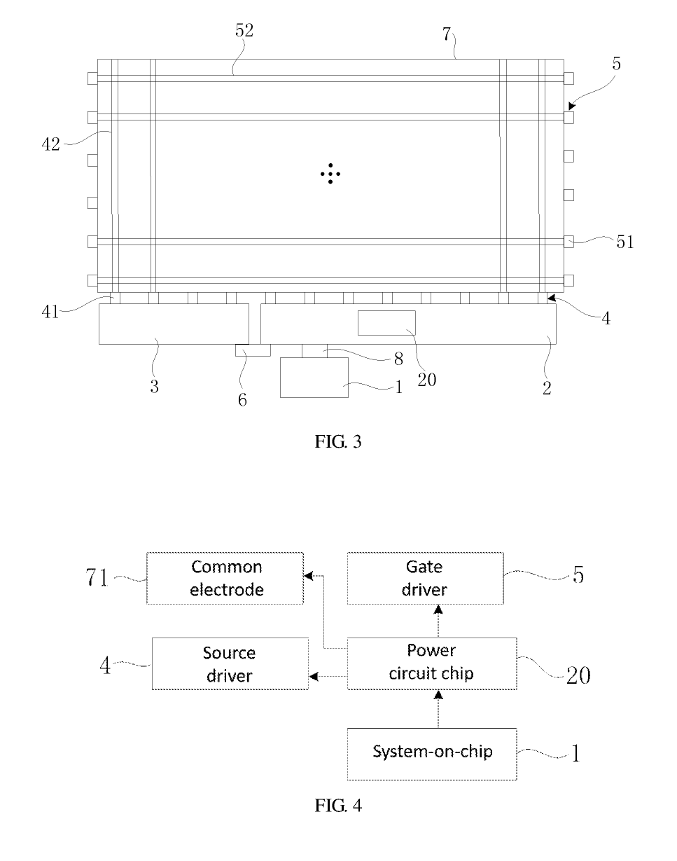

Please refer to FIG. 3 and FIG. 4, FIG. 3 is a schematic structural diagram of another display device including a display panel and a driving device thereof according to an embodiment of the present disclosure, and FIG. 4 is a schematic diagram showing a connection relationship between the power circuit chip and the related components shown in FIG. 3.

Specifically, on the basis of the foregoing first embodiment, the source driver 4 of the embodiment provides a plurality of source driving channels corresponding to the plurality of data lines 42. The gate driver 5 provides a plurality of gate driving channels corresponding to the plurality of scanning lines 52. The gate driver 5 includes, for example, a gate on array (GOA) circuit disposed on opposite sides of the display panel 7. The data lines 42 are respectively connected to the corresponding transmission circuit board 2 or the transmission circuit board 3 through the corresponding source COF 41. The system-on-chip 1 receives the image data signal to be transmitted and processes the image data to be transmitted through the row expansion module and the column expansion module. Then, it is transmitted to the source driver 4 through the transmission circuit board 2 and the transmission circuit board 3, and the gate driver 5 is controlled to sequentially turn on the plurality of scan lines 52. At the same time, the image data is sent to the source driver 4, and the source driver 4 drives the corresponding pixel unit to display according to the image data.

In view of the above, the output of the system-on-chip 1 is connected to the transmission circuit board 2, for example, to the transmission circuit board 2 via one flexible flat cable (FFC), and the power circuit chip 20 is disposed on the transmission circuit board 2.

More specifically, as shown in FIG. 4, the power supply circuit chip 20 connects the system-on-chip 1, the source driver 4, the gate driver 5, and the common electrode 71 of the display panel 7. The power circuit chip 20 integrates, for example, a PMIC circuit, a P-Gamma/VCOM circuit, and a Level Shifter circuit on a conventional T-CON board in a liquid crystal display. It can thus be used to generate a plurality of power supply voltages to the source driver 4 and gate driver 5, generate gamma voltage signals to the source driver 4, generate a common electrode voltage signal to the common electrode 71, and generate timing control voltage signals to the gate driver 5. For example, the power circuit chip 20 acts as a single chip that can generate AVDD, DVDD to the source driver 4, generate DVDD, Gate-On Voltage (VGH), and Gate-Off Voltage (VGL) to the gate driver 5, generate a plurality of channels such as fourteen gamma voltage signals GMA1˜GMA14 to the source driver 4, generate a common electrode voltage signal VCOM to the common electrode 71, and generate timing control voltage signals (e.g., two low frequency voltage signals LC1˜LC2 and six high frequency voltage signals HC1˜HCHC6) to the gate driver 5.

In summary, in the present embodiment, since the signal transmission distance from the output chip of the system-on-chip 1 to the source COF 41 respectively connected to the symmetrical positions of the display panel 7 are equal, that is, the impedance and loss of the transmission line are the same. Therefore, the source COF 41 at the symmetrical position is matched with the transmission path of equal length so that the impedance matching is uniform, thereby ensuring that the image data signals transmitted to the source COF 41 at the symmetrical position are the same. It can ensure the consistency of image display and improve anti-interference ability. Furthermore, a power supply circuit such as a PMIC circuit, a P-Gamma/VCOM circuit, and a Level Shifter circuit on a conventional T-CON board in a liquid crystal display is integrated on the transmission circuit board 2. When the display device factory selects the system-on-chip (SoC) including the T-CON function in the circuit board design of the original system-on-chip, it is not necessary to separately add the foregoing power supply circuit on the circuit board where the SoC is located. It reduces the design complexity and difficulty of the board where the SoC is located and is simple and fast. In addition, integrating a plurality of power supply circuit functions into a single chip simplifies the circuit design on the transmission circuit board 2 and effectively reduces the width of the transmission circuit board 2.

### Embodiment 3

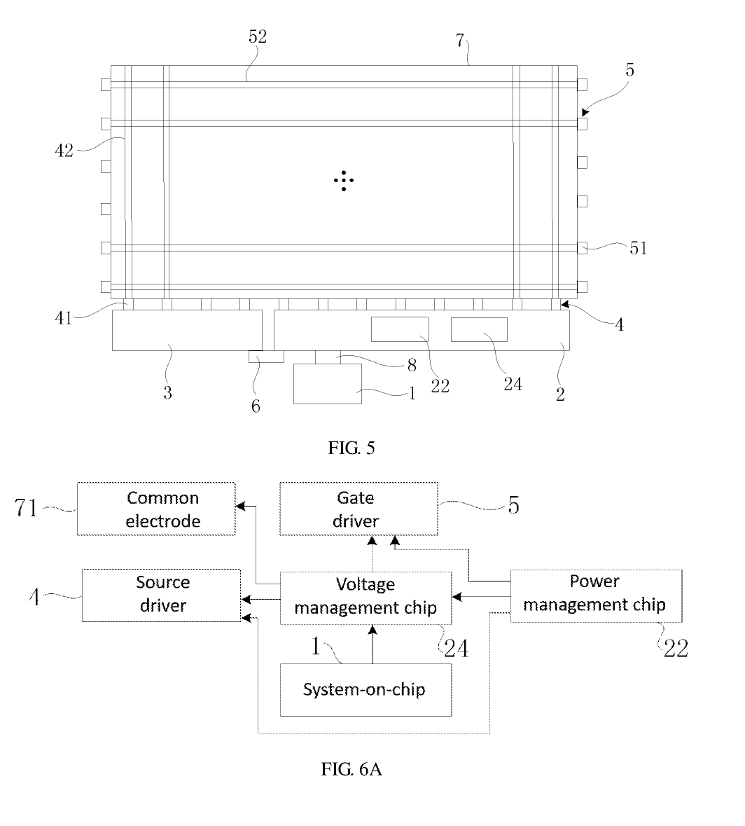

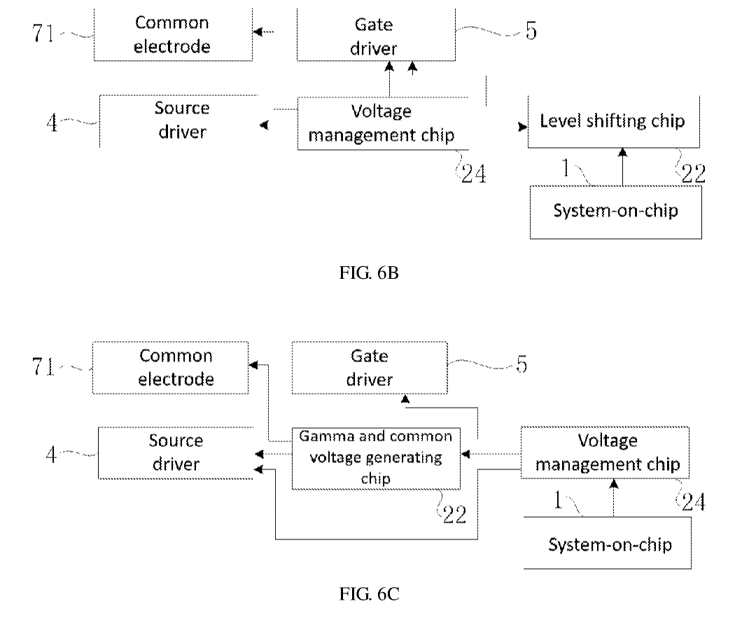

Please refer to FIG. 5 and FIG. 6A. FIG. 5 is a schematic structural diagram of still another display device including a display panel and a driving device thereof according to an embodiment of the present application. FIG. 6A is a schematic diagram showing the connection relationship between a power management chip and a voltage management chip and related components in a specific embodiment of the display device shown in FIG. 5.

In this embodiment, the output of the system-on-chip 1 is connected to the transmission circuit board 2, for example, to the transmission circuit board 2 via one flexible flat cable (FFC), and the power management chip 22 and the voltage management chip 24 are disposed on the transmission circuit board 2.

More specifically, as shown in FIG. 6A, the power management chip 22 is connected to the source driver 4, the gate driver 5, and the voltage management chip 24, and is used to generate a plurality of power supply voltages to the source driver 4, the gate driver 5, and the voltage management chip 24. The voltage management chip 24 is connected to the system-on-chip 1, the source driver 4, the common electrode 71 of the display panel 7, and the gate driver 5 for generating gamma voltage signals to the source driver 4, and generating a common electrode voltage signal to the common electrode 71 and generating timing control voltage signals to the gate driver 5. For example, the power management chip 22 uses, for example, a PMIC chip on a conventional T-CON board in a liquid crystal display for generating power voltages such as AVDD, DVDD, VGH, and VGL; the voltage management chip 24 integrates, for example, a P-Gamma/VCOM circuit and a Level Shifter circuit on a conventional T-CON board in a liquid crystal display for generating gamma voltage signals, a VCOM voltage signal, and timing control voltage signals (that is, a voltage signal required for the operation of the GOA type gate driver 5).

In other embodiments, as shown in FIG. 5 and FIG. 6B, the transmission circuit board 2 is provided with a voltage management chip 24 and a level shifting chip 22. The voltage management chip 24 is connected to the source driver 4, the gate driver 5, the common electrode 7 of the display panel 7, and the level shifting chip 22, and is for generating a plurality of power supply voltages to the source driver 4, the gate driver 5, and the level shifting chip 22, generating gamma voltage signals to the source driver 4, and generating a common electrode voltage signal to the common electrode 71. The level shifting chip 22 is connected to the system-on-chip 1 and the gate driver 5 for generating timing control voltage signals to the gate driver 5 in accordance with an input signal from the system-on-chip 1. For example, the level shifting chip 22 is integrated, for example, with a Level Shifter circuit on a conventional T-CON board in a liquid crystal display for supplying a voltage signal required for operation to a GOA type gate driver; the voltage management chip 24 is integrated, for example, with a PMIC and a P-Gamma/VCOM circuit on a conventional T-CON board in a liquid crystal display.

In another embodiment, as shown in FIG. 5 and FIG. 6C, the transmission circuit board 2 is provided with a voltage management chip 24 and a gamma and common voltage generating chip 22. The voltage management chip 24 is connected to the system-on-chip 1, the source driver 4, the gate driver 5, and the gamma and common voltage generating chip 22, and the voltage management chip 24 is used to generate a plurality of power supply voltages to the source driver 4, the gate driver 5 and the gamma and common voltage generating chip 22, and generate timing control voltage signals to the gate driver 5. The gamma and common voltage generating chip 22 is connected to the source driver 4 and the common electrode 71 of the display panel 7 for generating gamma voltage signals to the source driver 4 and generating a common electrode voltage signal to the common electrode 71. For example, the gamma and common voltage generating chip 22 is integrated, for example, with a P-Gamma/VCOM circuit on a conventional T-CON board in a liquid crystal display. The gamma and common voltage generating chip 22 is used to generate gamma voltage signals and a common electrode voltage signal; the voltage management chip 24 is integrated, for example, with a PMIC and a Level Shifter circuit on a conventional T-CON board in a liquid crystal display.

### Embodiment 4

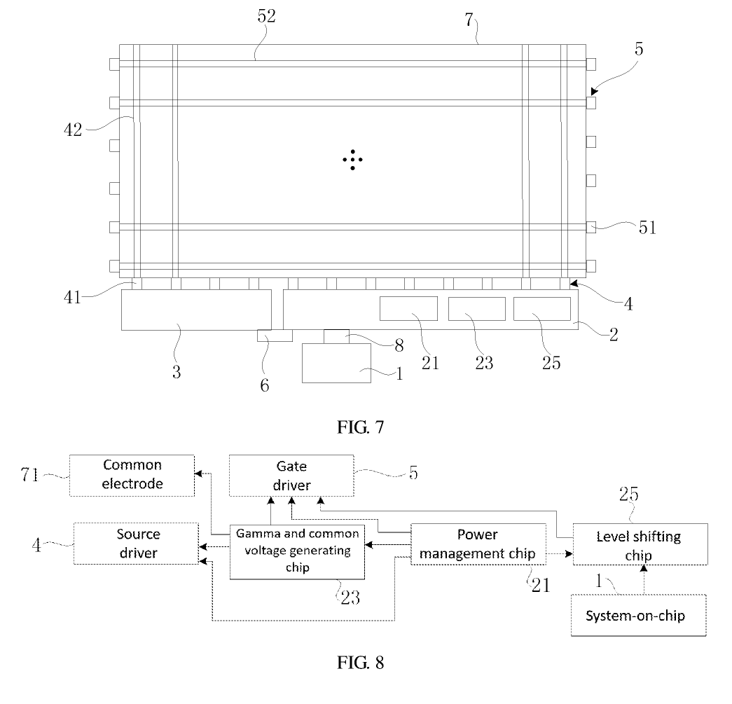

Please refer to FIG. 7 and FIG. 8, FIG. 7 is a schematic structural diagram of still another display device including a display panel and a driving device thereof according to an embodiment of the present application. FIG. 8 is a schematic diagram showing the connection relationship between the power management chip, the gamma and common voltage generating chips, and the level shifting chip and related components shown in FIG. 7.

In this embodiment, the output end of the system-on-chip 1 is connected to the transmission circuit board 2, for example, to the transmission circuit board 2 through a single flexible flat cable (FFC). A power management chip 21, a gamma and common voltage generating chip 23, and a level shifting chip 25 are disposed on the transmission circuit board 2.

More specifically, as shown in FIG. 8, the power management chip 21 is connected to the source driver 4, the gate driver 5, the gamma and common voltage generating chip 23, and the level shifting chip 25 for generating a plurality of power supply voltages to the source driver 4, the gate driver 5, the gamma and common voltage generating chip 23, and the level shifting chip 25. The gamma and common voltage generating chip 23 is connected to the source driver 4 and the common electrode 71 of the display panel 7 for generating gamma voltage signals to the source driver 4 and generating a common electrode voltage signal to the common electrode 71. The level shifting chip 25 is connected to the system-on-chip 1 and the gate driver 5 for generating timing control voltage signals to the gate driver 5. For example, the power management chip 21 can use a PMIC chip on a conventional T-CON board in a liquid crystal display for generating power voltages such as AVDD, DVDD, VGH, and VGL. The gamma and common voltage generating chip 23 is integrated, for example, with a P-Gamma/VCOM circuit on a conventional T-CON board in a liquid crystal display for generating gamma voltage signals and a common electrode voltage signal. The level shifting chip 25 is integrated, for example, with a Level Shifter circuit on a conventional T-CON board in a liquid crystal display for supplying a voltage signal (or timing control voltage signals) required for operation to a GOA type gate driver.

In summary, the power circuit of the PMIC circuit, the P-Gamma/VCOM circuit, and the Level Shifter circuit on the conventional T-CON board of the liquid crystal display is integrated on the transmission circuit board 2. The display device factory does not need to separately add the foregoing power circuit on the circuit board where the system-on-chip (SoC) is located when the circuit board design of the original SoC is selected to use the system-on-chip including the T-CON function. It reduces the design complexity and difficulty of the board where the SoC is located, and is simple and fast.

The above is a further detailed description of the present application in conjunction with the specific preferred embodiments, and the specific implementation of the present application is not limited to the description. It will be apparent to those skilled in the art that the present invention can be made in the form of the present invention without departing from the scope of the present invention.

What is claimed is:

1. A driving device for a display panel (7), comprising: a system-on-chip (1), a first transmission circuit board (2/3), a second transmission circuit board (3/2), a source driver (4) and a gate driver (5);
wherein the first transmission circuit board (2/3) and the second transmission circuit board (3/2) are juxtaposed on a source side of the display panel (7) and connected by a connector (6), the source driver (4) comprises a plurality of source chip on films (COFs) (41) on the source side and connected to the display panel (7), the first transmission circuit board (2/3) and the second transmission circuit board (3/2) are respectively connected to corresponding ones of the plurality of source COFs (41);
wherein an output signal of the system-on-chip (1) in operation is transmitted to the corresponding source COF(s) (41) via the first transmission circuit board (2/3), or transmitted to the corresponding source COF(s) (41) via a transmission path formed sequentially by the first transmission circuit board (2/3), the connector (6), and the second transmission circuit board (3/2), such that signal transmission distances from a data output end of the system-on-chip (1) to the source COFs (41) respectively connected to symmetrical positions (A, A′) of the display panel (7) are equal.

2. The driving device according to claim 1, wherein a length of the first transmission circuit board (2/3) is greater than a length of the second transmission circuit board (3/2), and a number of the source COF(s) (41) connected to the first transmission circuit board (2/3) is greater than a number of the source COF(s) (41) connected to the second transmission circuit board (3/2).

3. The driving device according to claim 2, further comprising:
a second connector (8), the data output end of the system-on-chip (1) is connected to the first transmission circuit board (2/3) through the second connector (8).

4. The driving device according to claim 3, wherein the second connector (8) is one flexible flat cable and thereby a circuit board (10) where the system-on-chip is located and the first transmission circuit board (2/3) are electrically connected only through the flexible flat cable.

5. The driving device according to claim 2, wherein a power circuit chip (20) is disposed on the first transmission circuit board (2), and the power circuit chip (20) is connected to the system-on-chip (1), the source driver (4), the gate driver (5), and a common electrode (71) of the display panel (7); the power circuit chip (20) is configured to generate a plurality of power supply voltages to the source driver (4) and the gate driver (5), generate gamma voltage signals to the source driver (4), generate a common electrode voltage signal to the common electrode (71), and generate timing control voltage signals to the gate driver (5).

6. The driving device according to claim 2, wherein the first transmission circuit board (2) is provided with a power management chip (22) and a voltage management chip (24); the power management chip (22) is connected to the source driver (4), the gate driver (5) and the voltage management chip (24), and is configured to generate a plurality of power supply voltages to the source driver (4), the gate driver (5) and the voltage management chip (24); the voltage management chip (24) is connected to the system-on-chip (1), the source driver (4), a common electrode (71) of the display panel (7), and the gate driver (5), and is configured to generate gamma voltage signals to the source driver (4), generate a common electrode voltage signal to the common electrode (71), and generate timing control voltage signals to the gate driver (5).

7. The driving device according to claim 2, wherein the first transmission circuit board (2) is provided with a voltage management chip (24) and a level shifting chip (22); the voltage management chip (24) is connected to the source driver (4), the gate driver (5), a common electrode of the display panel (7), and the level shifting chip (22), and is configured to generate a plurality of power supply voltages to the source driver (4), the gate driver (5), and the level shifting chip (22), generate gamma voltage signals to the source driver (4) and generate a common electrode voltage signal to the common electrode (71); the level shifting chip is coupled to the system-on-chip (1) and the gate driver (5) and configured to generate timing control voltage signals to the gate driver (5).

8. The driving device according to claim 2, wherein the first transmission circuit board (2) is provided with a voltage management chip (24) and a gamma and common voltage generating chip (22); the voltage management chip (24) is connected to the system-on-chip (1), the source driver (4), the gate driver (5), and the gamma and common voltage generating chip (22), and is configured to generate a plurality of power supply voltages to the source driver (4), the gate driver (5) and the gamma and common voltage generating chip (22), and generate timing control voltage signals to the gate driver (5); the gamma and common voltage generating chip (22) connects the source driver (4) and a common electrode (71) of the display panel (7), and is configured to generate gamma voltage signals to the source driver (4) and generate a common electrode voltage signal to the common electrode (71).

9. The driving device according to claim 2, wherein the first transmission circuit board (2) is provided with a power management chip (21), a gamma and common voltage generating chip (23) and a level shifting chip (25); the power management chip (21) is connected to the source driver (4), the gate driver (5), the gamma and common voltage generating chip (23), and the level shifting chip (25), and is configured to generate a plurality of power supply voltages to the source driver (4), the gate driver (5), the gamma and common voltage generating chip (23), and the level shifting chip (25); the gamma and common voltage generating chip (23) connects the source driver (4) and a common electrode (71) of the display panel (7), and is configured to generate gamma voltage signals to the source driver (4) and generate a common electrode voltage signal to the common electrode (71); the level shifting chip (25) is connected to the system-on-chip (1) and the gate driver (5), and is configured to generate timing control voltage signals to the gate driver (5).

10. A display device, comprising a display panel (7) and a driving device for the display panel (7);
wherein the driving device comprises: a system-on-chip (1), a first transmission circuit board (2/3), a second transmission circuit board (3/2), a source driver (4) and a gate driver (5);
wherein the first transmission circuit board (2/3) and the second transmission circuit board (3/2) are juxtaposed on a source side of the display panel (7) and connected by a connector (6), the source driver (4) comprises a plurality of source chip on films (COFs) (41) on the source side and connected to the display panel (7), the first transmission circuit board (2/3) and the second transmission circuit board (3/2) are respectively connected to corresponding ones of the plurality of source COFs (41);
wherein an output signal of the system-on-chip (1) in operation is transmitted to the corresponding source COF(s) (41) via the first transmission circuit board (2/3), or transmitted to the corresponding source COF(s) (41) via a transmission path formed sequentially by the first transmission circuit board (2/3), the connector (6), and the second transmission circuit board (3/2), such that signal transmission distances from a data output end of the system-on-chip (1) to the source COF(s) (41) respectively connected to symmetrical positions (A, A′) of the display panel (7) are equal.

11. The display device according to claim 10, wherein a length of the first transmission circuit board (2/3) is greater than a length of the second transmission circuit board (3/2), and a number of the source COF(s) (41) connected to the first transmission circuit board (2/3) is greater than a number of the source COF(s) (41) connected to the second transmission circuit board (3/2).

12. The display device according to claim 11, further comprising:
a second connector (8), the data output end of the system-on-chip (1) is connected to the first transmission circuit board (2/3) through the second connector (8).

13. The display device according to claim 12, wherein the second connector (8) is one flexible flat cable and thereby a circuit board (10) where the system-on-chip is located and the first transmission circuit board (2/3) are electrically connected only through the flexible flat cable.

14. The display device according to claim 11, wherein a power circuit chip (20) is disposed on the first transmission circuit board (2), and the power circuit chip (20) is connected to the system-on-chip (1), the source driver (4), the gate driver (5), and a common electrode (71) of the display panel (7); the power circuit chip (20) is configured to generate a plurality of power supply voltages to the source driver (4) and the gate driver (5), generate gamma voltage signals to the source driver (4), generate a common electrode voltage signal to the common electrode (71), and generate timing control voltage signals to the gate driver (5).

15. The display device according to claim 11, wherein the first transmission circuit board (2) is provided with a power management chip (22) and a voltage management chip (24); the power management chip (22) is connected to the source driver (4), the gate driver (5) and the voltage management chip (24), and is configured to generate a plurality of power supply voltages to the source driver (4), the gate driver (5) and the voltage management chip (24); the voltage management chip (24) is connected to the system-on-chip (1), the source driver (4), a common electrode (71) of the display panel (7), and the gate driver (5), and is configured to generate gamma voltage signals to the source driver (4), generate a common electrode voltage signal to the common electrode (71), and generate timing control voltage signals to the gate driver (5).

16. The display device according to claim 11, wherein the first transmission circuit board (2) is provided with a voltage management chip (24) and a level shifting chip (22); the voltage management chip (24) is connected to the source driver (4), the gate driver (5), a common electrode of the display panel (7), and the level shifting chip (22), and is configured to generate a plurality of power supply voltages to the source driver (4), the gate driver (5), and the level shifting chip (22), generate gamma voltage signals to the source driver (4) and generate a common electrode voltage signal to the common electrode (71); the level shifting chip is coupled to the system-on-chip (1) and the gate driver (5) and configured to generate timing control voltage signals to the gate driver (5).

17. The display device according to claim 11, wherein the first transmission circuit board (2) is provided with a voltage management chip (24) and a gamma and common voltage generating chip (22); the voltage management chip (24) is connected to the system-on-chip (1), the source driver (4), the gate driver (5), and the gamma and common voltage generating chip (22), and is configured to generate a plurality of power supply voltages to the source driver (4), the gate driver (5) and the gamma and common voltage generating chip (22), and generate timing control voltage signals to the gate driver (5); the gamma and common voltage generating chip (22) connects the source driver (4) and a common electrode (71) of the display panel (7), and is configured to generate gamma voltage signals to the source driver (4) and generate a common electrode voltage signal to the common electrode (71).

18. The display device according to claim 11, wherein the first transmission circuit board (2) is provided with a power management chip (21), a gamma and common voltage generating chip (23) and a level shifting chip (25); the power management chip (21) is connected to the source driver (4), the gate driver (5), the gamma and common voltage generating chip (23), and the level shifting chip (25), and is configured to generate a plurality of power supply voltages to the source driver (4), the gate driver (5), the gamma and common voltage generating chip (23), and the level shifting chip (25); the gamma and common voltage generating chip (23) connects the source driver (4) and a common electrode (71) of the display panel (7), and is configured to generate gamma voltage signals to the source driver (4) and generate a common electrode voltage signal to the common electrode (71);
the level shifting chip (25) is connected to the system-on-chip (1) and the gate driver (5), and is configured to generate timing control voltage signals to the gate driver (5).
